(19) United States
(12) Patent Application Publication
(10) Pub. No.: US 2025/0006417 A1
(43) Pub. Date: Jan. 2, 2025

(54) TRANSFORMER

(71) Applicant: Coilcraft Inc., Cary, IL (US)

(72) Inventors: David Cherek, Marengo, IL (US); Scott Hess, Crystal Lake, IL (US); Kurt Smith, Crystal Lake, IL (US)

(21) Appl. No.: 18/216,976

(22) Filed: Jun. 30, 2023

(51) Int. Cl. H01F 27/28; H01F 27/24; H01F 27/29

(52) U.S. Cl. CPC H01F 27/2804; H01F 27/24; H01F 27/2823; H01F 27/29

(57) ABSTRACT

Exemplarily, a transformer includes a primary winding with two layers and a secondary winding with two layers. One turn in each of the first and second layers of the primary winding face one turn in each of the first and second layers in the secondary winding. Spacing between adjacent turns in the primary winding is constant. Spacing between adjacent turns in the secondary winding is constant.

### CROSS REFERENCE TO RELATED APPLICATIONS

[Not Applicable]

### BACKGROUND

Generally, this application relates to transformers or coupled inductors, such as those used with gate-drive circuits. Such transformers may be suitable for use in open-loop LLC converters. Some non-limiting examples where such transformers or coupled inductors can be used include circuitry for high voltage isolation communication transformers, common mode chokes, SEPIC convertors, half bridge convertors, full bridge convertors, and DC/DC converters.

### SUMMARY

According to embodiments, a transformer includes: a core portion including a first lengthwise region extending between a first distal end of the core and a first lengthwise endpoint and a second lengthwise region next to the first lengthwise region extending between a second distal end of the core and a second lengthwise endpoint; a primary winding arranged around the first lengthwise region of the core portion, wherein the primary winding comprises a plurality of layers, wherein each layer comprises a plurality of turns, wherein adjacent turns in each layer are arranged at a constant distance from each other; and a secondary winding arranged around the second lengthwise region of the core portion, wherein the secondary winding comprises a plurality of layers, wherein each layer comprises a plurality of turns, wherein adjacent turns in each layer are arranged at a constant distance from each other, wherein the plurality of turns of the primary winding are wound around the first lengthwise region starting proximate the first distal end and extending towards the first lengthwise endpoint in a first layer, and then reversing direction and extending back towards the first distal end, thereby forming two layers of turns in a second layer, the second layer being arranged around the first layer, wherein the plurality of turns of the second winding are wound around the second lengthwise region starting proximate the second distal end and extending towards the second lengthwise endpoint in a first layer, and then reversing direction and extending back towards the second distal end in a second layer, the second layer being arranged around the first layer, wherein a first portion of a capacitor is formed in the primary winding by one turn from each layer directly facing the first lengthwise endpoint, and wherein a second portion of the capacitor is formed in the secondary winding by one turn from each layer directly facing the second lengthwise endpoint. The primary winding may have only two layers of turns. Centerline of wire in the first layer of the primary winding may be substantially aligned with centerline of wire in the second layer of the primary winding, and wherein centerline of wire in the first layer of the secondary winding may be substantially aligned with centerline of wire in the second layer of the secondary winding. The transformer may further include a first primary terminal, a second primary terminal, a first secondary terminal, a second secondary terminal, a first primary lead wire connected to the first primary terminal, a second primary lead wire connected to the second primary terminal, a first secondary lead wire connected to the first secondary terminal, and a second secondary lead wire connected to the second secondary terminal, wherein an initial turn in an inner-most layer of the primary winding is connected to the first primary lead wire, wherein a final turn in an outer-most layer of the primary winding is connected to the second primary lead wire, wherein an initial turn in an inner-most layer of the secondary winding is connected to the first secondary lead wire, and wherein a final turn in an outer-most layer of the secondary winding is connected to the second secondary lead wire. A capacitance of the capacitor may be between approximately 0.1-1.5 pF (e.g., 0.7 pF). The leakage inductance of the transformer may be between approximately 10-12 pH.

The transformer may further include: a first lateral core portion coupled with the first distal end of the core portion; a second lateral core portion coupled with the second distal end of the core portion; and an upper core portion coupled with the first lateral core portion and the second lateral core portion. The first lateral core portion may be directly coupled (e.g., integrated) with the first distal end of the core portion, and wherein the second lateral core portion may be directly coupled (e.g., integrated) with the second distal end of the core portion. The upper core portion may be adhered to the first lateral core portion and to the second lateral core portion. The transformer may comprise a gate-drive transformer. The first layer of the primary winding and the first layer of the secondary winding may be wound directly on the core portion. The primary winding may have between approximately 10-40 turns (e.g., 24 turns), and wherein the secondary winding may have between approximately 10-40 turns (e.g., 24 turns).

According to embodiments a method for assembling a transformer including a core portion having a first lengthwise region defined by a first distal end and a first lengthwise endpoint, a second lengthwise region defined by a second distal end and a second lengthwise endpoint, and a core portion, includes: arranging a primary winding around the core portion by beginning the primary winding proximate the first distal end of the core portion and continuing to add turns in a first layer extending towards the first lengthwise endpoint, and subsequently reversing direction and continuing to add turns in a second layer extending back towards the first distal end, wherein adjacent turns are spaced by a constant distance; arranging a secondary winding around the core portion by beginning the secondary winding proximate the second distal end of the core portion and continuing to add turns in a first layer extending towards the second lengthwise endpoint, and subsequently reversing direction and continuing to add turns in a second layer extending back towards the second distal end, wherein the adjacent turns are spaced by a constant distance. The transformer may further include a first lateral core portion coupled to the first distal end of the core portion, and a second lateral core portion coupled to the second distal end of the core portion, the method may further include attaching an upper core portion to the first lateral core portion and to the second lateral core portion. Attaching the upper core portion may be performed after arranging the primary winding and arranging the secondary winding. Attaching the upper core portion may include forming a gap between the upper core portion and the first lateral core portion, and forming a gap between the upper core portion and the second lateral core portion. The method may further include: forming a third layer and a fourth layer in the primary winding as like forming the first layer and the second layer of the primary winding; and forming a third layer and a fourth layer in the secondary winding as like forming the first layer and the second layer of the secondary winding.

### BRIEF DESCRIPTION OF SEVERAL VIEWS OF THE DRAWINGS

FIG. 1 illustrates a perspective view of a transformer, according to embodiments.

FIG. 2 illustrates an elevational view of the transformer, according to embodiments.

FIG. 3 illustrates a cross-sectional view of the transformer, according to embodiments.

FIG. 4 illustrates a bottom view of the transformer, according to embodiments.

FIG. 5 is a circuit diagram modeling the transformer, according to embodiments.

FIG. 6 is a flowchart for a method of assembling a transformer, according to embodiments.

The foregoing summary, as well as the following detailed description of certain techniques of the present application, will be better understood when read in conjunction with the appended drawings. For the purposes of illustration, certain techniques are shown in the drawings. It should be understood, however, that the claims are not limited to the arrangements and instrumentality shown in the attached drawings. Furthermore, the appearance shown in the drawings is one of many ornamental appearances that can be employed to achieve the stated functions of the system.

### DETAILED DESCRIPTION

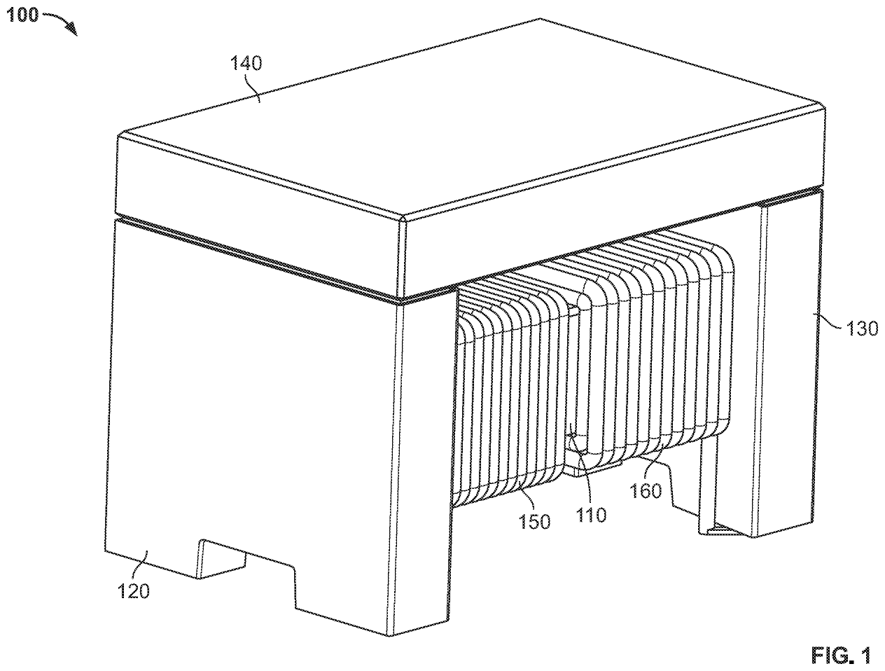

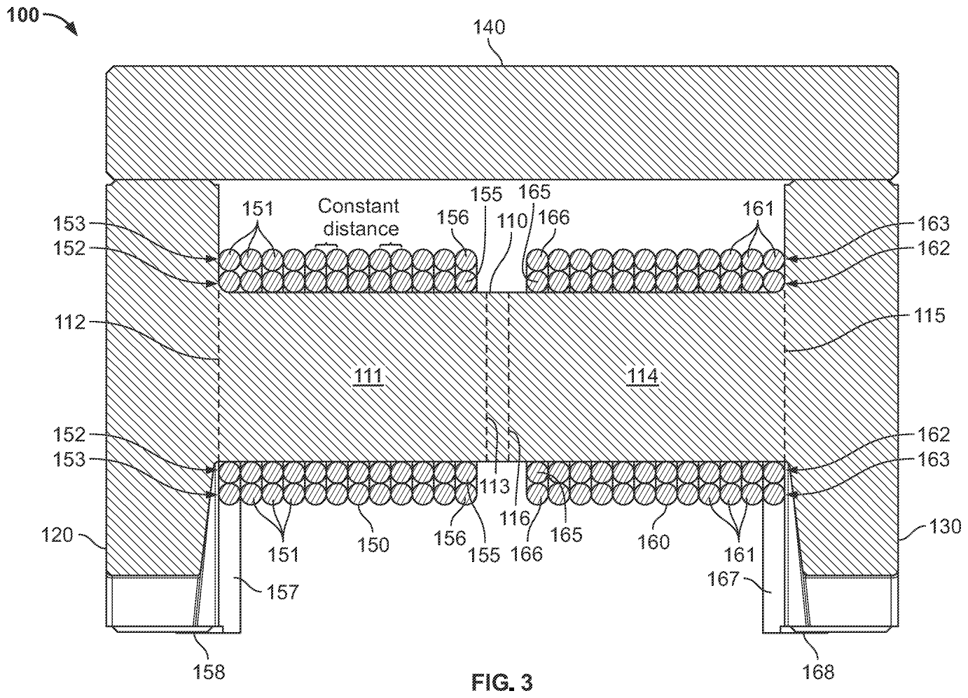

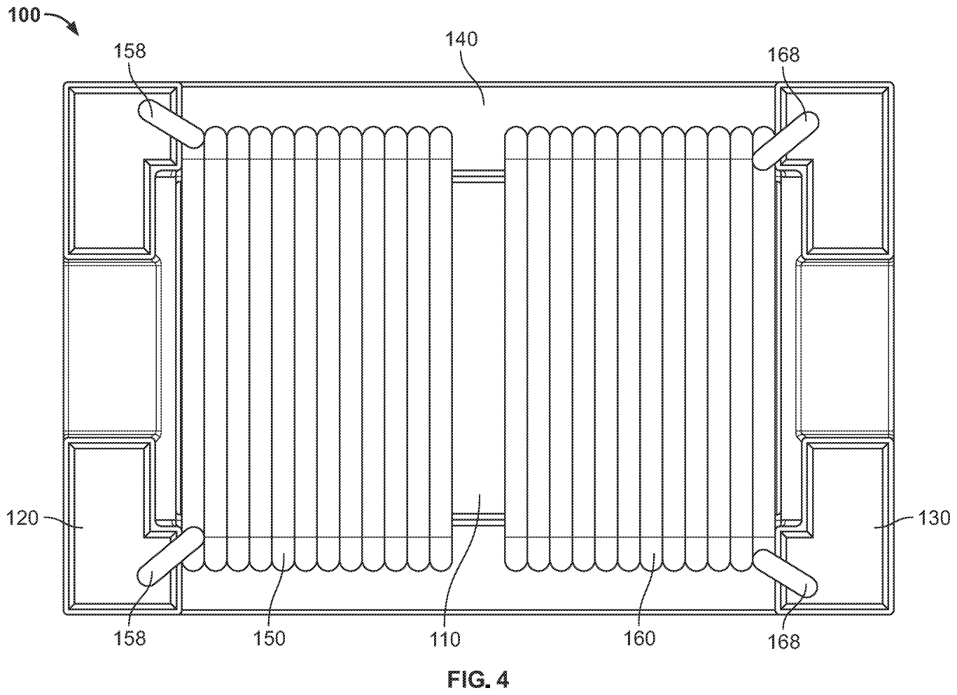

FIGS. 1-4 illustrate a perspective view, elevational view, cross-sectional view, and bottom view, respectively, of transformer 100, according to embodiments. Transformer 100 includes core portion 110, first lateral core portion 120, second lateral core portion 130, upper core portion 140, primary winding 150, and secondary winding 160. Transformer 100 may form part of a circuit, such as a gate-drive circuit that drives a gate of a transistor such as a MOSFET transistor. Transformer 100 may be used as a component in an open-loop LLC converter circuit.

Core portion 110 may have a rectangular solid shape, as shown. Core portion 110 may have other shapes, such as a cylindrical shape. Primary winding 150 and secondary winding 160 may be wound around core portion 110. Core portion may have an outer diameter along a depth dimension that is less than a depth of first lateral core portion 120 and second lateral core portion 130. Core portion 110 may have an outer diameter along a height dimension that is less than the height of first lateral core portion 120 and second lateral core portion 130.

Core portion 110 includes first lengthwise region 111, first distal end 112, first lengthwise endpoint 113, second lengthwise region 114, second distal end 115, and second lengthwise endpoint 116. First distal end 112 is defined by an end of core portion 110 proximate first lateral core portion 120, or an intersection between core portion 110 and first lateral core portion 120. Second distal end 115 is defined by an end of core portion 110 proximate second lateral core portion 130, or an intersection between core portion 110 and second lateral core portion 130. First lengthwise region 111 is defined as the region between first distal end 112 and first lengthwise endpoint 113. First lengthwise endpoint 113 may be at any suitable location on core portion 110 between where primary winding 150 and secondary winding 160 are arranged. Second lengthwise region 114 is defined as the region between second distal end 115 and second lengthwise endpoint 116. Second lengthwise endpoint 116 may be at any suitable location on core portion 110 between where primary winding 150 and secondary winding 160 are arranged.

First lateral core portion 120 may include one or more legs and corresponding feet (as shown, two legs and feet). The feet of first lateral core portion 120 may be configured to rest on a substrate, such as a circuit board. The feet may include a recess or other feature to accommodate all or a portion of terminals 158, discussed below. Alternatively, the feet may be substantially flat without any such feature.

Second lateral core portion 130 may include one or more legs and corresponding feet (as shown, two legs and feet). The feet of second lateral core portion 130 may be configured to rest on a substrate, such as a circuit board. The feet may include a recess or other feature to accommodate all or a portion of terminals 168, discussed below. Alternatively, the feet may be substantially flat without any such feature.

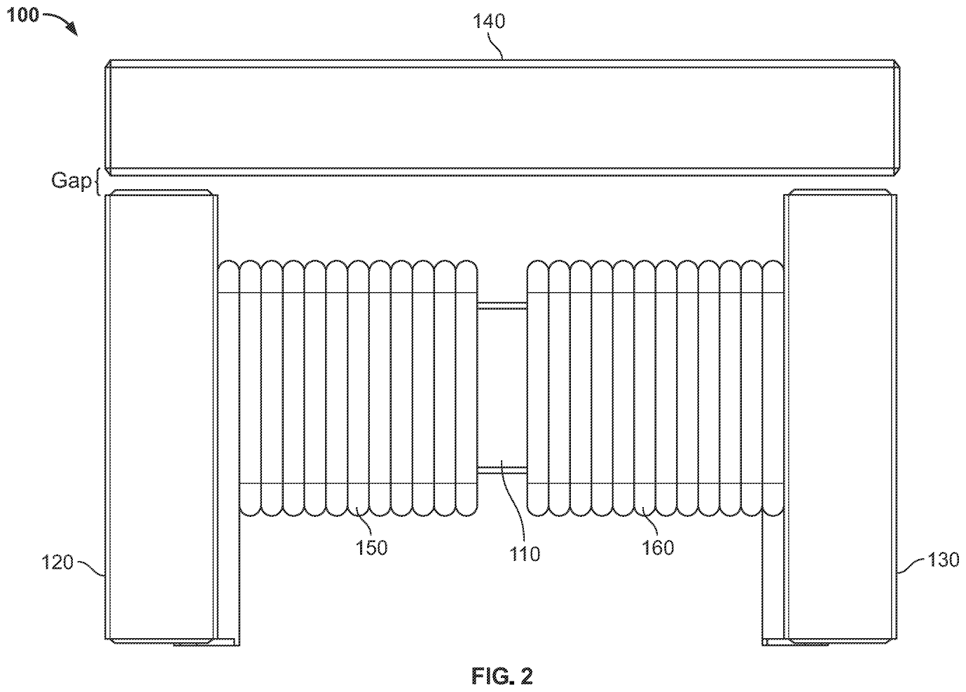

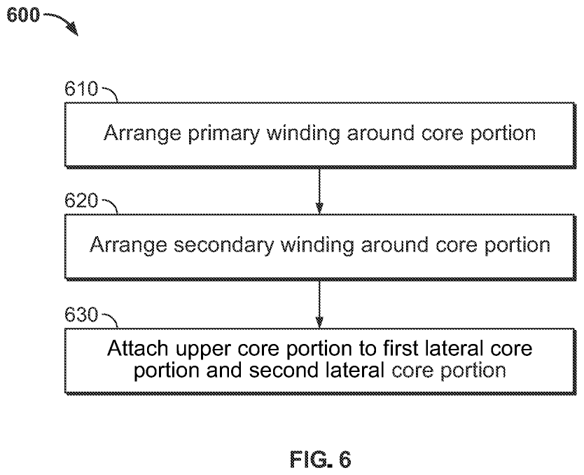

Upper core portion 140 may be a separate piece from core portion 110, first lateral core portion 120, and/or second lateral core portion 130. Upper core portion 140 may abut first lateral core portion 120 (e.g., on an upper surface of first lateral core portion 120), or, as shown in FIG. 2, a gap may be maintained therebetween. For example, an epoxy or other filler or buffer material or other type of spacer may be located between upper core portion 140 and first lateral core portion 120 to maintain a gap. The gap may be between 0.02-0.10 mm. An adhesive or epoxy material may maintain a fixed positional relationship between upper core portion 140 and first lateral core portion 120. Upper core portion 140 may abut second lateral core portion 130 (e.g., on an upper surface of second lateral core portion 130), or, as shown in FIG. 2, a gap may be maintained therebetween. The gap may be between 0.02-0.10 mm. For example, an epoxy or other filler or buffer material or other type of spacer may be located between upper core portion 140 and second lateral core portion 130 to maintain a gap. An adhesive or epoxy material may maintain a fixed positional relationship between upper core portion 140 and second lateral core portion 130. As further discussed in context of FIG. 6, upper core portion 140 may be added to transformer 100 after primary winding 150 and secondary winding 160 have been wound.

Together, core portion 110, first lateral core portion 120, second lateral core portion 130, and upper core portion 140 form a magnetic core, which facilitates transfer of energy between primary winding 150 and secondary winding 160.

Primary winding 150 may include a conductor, and formed of a material such as copper or copper-clad aluminum. The conductor may be insulated, for example, by a material such as polyester. Primary winding 150 may be wound directly onto core portion 110 (layer 152 abuts core portion 110), or there may be an intermediate structure or material between primary winding 150 and core portion 110. Primary winding 150 may extend between two terminals 158. Primary winding 150 may be wound in a number of turns 151 around first lengthwise region 111 of core portion 110. Primary winding 150 may be wound starting from a first primary lead wire connected to a terminal 158. Starting from the first primary lead wire, turns 151 in first layer 152 are formed by winding the conductor around first lengthwise region 111. Turns 151 are added, progressing from first distal end 112, and extending towards first lengthwise endpoint 113. Turns 151 in first layer 152 are spaced from each other at a constant distance. In other words, the distance between the first and second turn is the same as the distance between the second and third turn in first layer 152.

At some point, the direction of winding in primary winding 150 is reversed, such that one turn 155 in first layer 152 directly faces first lengthwise endpoint 113. Turns 151 are then added in second layer 153, such that one turn 156 in second layer 153 is directly facing first lengthwise endpoint 113. Turns 151 are added in second layer 153, extending from turn 156 towards first distal end 112. Turns 151 in second layer 153 are spaced from each other at a constant distance. Turns 151 in second layer 153 may be directly on top of turns in first layer 152 (as shown, such that centerlines of the conductor are aligned vertically), or turns 151 may be staggered between first layer 152 and second layer 153 (such as completely or partially staggered). The constant distance between turns in first layer 152 and turns in second layer 153 may be the same. After finishing second layer 153, additional layers (e.g., third and fourth layers, fifth and sixth layers, etc.) may be added in a similar manner. Whether or not additional layers are added, after the final turn 151 is wound around core portion 110, the conductor extends to a second primary lead wire, which is then connected to a terminal 158. Terminals 158 may comprise solder pads, portions of a ball-grid array, through pins, or the like. The number of turns 151 in each layer may be between 10-40, such as 24 turns 151 in first layer 152 and 24 turns 151 in second layer 153.

Secondary winding 160 may be similar or identical to primary winding 150. Secondary winding 160 may include a conductor, and formed of a material such as copper or copper-clad aluminum. The conductor may be insulated, for example, by a material such as polyester. Secondary winding 160 may be wound directly onto core portion 110 (layer 162 abuts core portion 110), or there may be an intermediate structure or material between secondary winding 160 and core portion 110. Secondary winding 160 may extend between two terminals 168. Secondary winding 160 may be wound in a number of turns 161 around second lengthwise region 114 of core portion 110. Secondary winding 160 may be wound starting from a first secondary lead wire connected to a terminal 168. Starting from the first secondary lead wire, turns 161 in first layer 162 are formed by winding the conductor around second lengthwise region 114. Turns 161 are added, progressing from second distal end 115, and extending towards second lengthwise endpoint 116. Turns 161 in first layer 162 are spaced from each other at a constant distance. In other words, the distance between the first and second turn is the same as the distance between the second and third turn in first layer 162.

At some point, the direction of winding in secondary winding 160 is reversed, such that one turn 165 in first layer 162 directly faces second lengthwise endpoint 116. Turns 161 are then added in second layer 163, such that one turn 166 in second layer 163 is directly facing second lengthwise endpoint 116. Turns 161 are added in second layer 163, extending from turn 166 towards second distal end 115. Turns 161 in second layer 163 are spaced from each other at a constant distance. Turns 161 in second layer 163 may be directly on top of turns in first layer 162 (as shown, such that centerlines of the conductor are vertically aligned), or turns 161 may be staggered between first layer 162 and second layer 163 (such as completely or partially staggered). The constant distance between turns in first layer 162 and turns in second layer 163 may be the same. After finishing second layer 163, additional layers (e.g., third and fourth layers, fifth and sixth layers, etc.) may be added in a similar manner. Whether or not additional layers are added, after the final turn 161 is wound around core portion 110, the conductor extends to a second secondary lead wire, which is then connected to a terminal 168. Terminals 168 may comprise solder pads, portions of a ball-grid array, through pins, or the like. The number of turns 161 in each layer may be between 10-40, such as 24 turns 161 in first layer 152 and 24 turns 161 in second layer 153.

Primary winding 150 and secondary winding 160 may be arranged such that transformer has a 1:1 ratio, although other ratios are possible. For example, the number of turns 151 may be equal to the number of turns 161, thereby resulting in a ratio of 1:1. The number of turns 151 may not be equal to the number of turns 161. For example, there may be twice as many turns 151 as turns 161. Additionally there may be one or more additional windings parallel to secondary winding 160 creating a transformer with multiple outputs.

Primary winding 150 and secondary winding 160 are arranged such that turns 155, 156 face turns 165, 166, thereby forming a winding-to-winding capacitor. If additional layers are present (beyond layers 152, 153, 162, 163), then additional facing turns would also form portions of the winding-to-winding capacitor. Such an arrangement of primary winding 150 and secondary winding 160 may result in a relatively low capacitance in the winding-to-winding capacitor formed by 155, 156, 165, 166. For example, the winding-to-winding capacitance could be between approximately 0.1-1.5 pF (for example, 0.7 pF). A reduced winding-to-winding capacitance may result in reduced noise in an open-loop LLC converter. In “core and bobbin” designs, greater winding-to-winding capacitances may be found between primary and secondary windings, and embodiments herein may result in a reduced winding-to-winding capacitance.

Furthermore, the arrangement of primary winding 150 and secondary winding 160 may result in leakage inductance that can be controlled with greater tolerance (e.g., less than 10%) between transformers 100. Core and bobbin transformers may have larger tolerances of leakage inductance (e.g., 30%), thereby making circuit behavior more imprecise from one unit to the next. Moreover, leakage inductance may be relatively high in transformer 100, such as between 10-12 μH. This is substantially larger than what might be seen in core and bobbin transformers (e.g., 2-4 μH). Having a larger leakage inductance may allow for an external matching inductor to be eliminated, thereby simplifying a circuit and reducing costs.

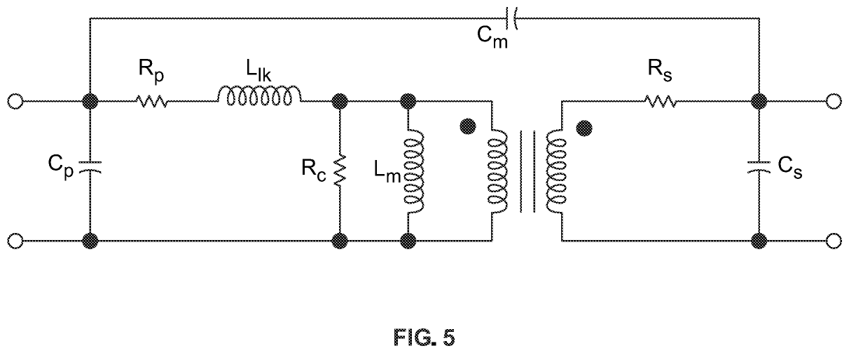

FIG. 5 is a circuit diagram modeling transformer 100, according to embodiments. Modeling transformer 100 can be done by considering Cₚ (capacitance of primary winding 150), Rₚ (DC resistance of primary winding 150), Lₗₖ (leakage inductance), R_{c} (core-loss resistance), Lₘ (magnetizing inductance), Cₘ (winding-to-winding capacitance), Rₛ (DC resistance of secondary winding 160), and Cₛ (capacitance of secondary winding 160). As discussed above, Lₗₖ may be relatively large (e.g., between 10-12 μH, such as 11 μH). Further, as discussed above Cₘ (the winding-to-winding capacitance) may be relatively low (e.g., between 0.1-15. pF, such as 0.7 pF). Other exemplary values for transformer 100 are: Cₚ=3.5 pF; Rₚ=0.4Ω; Rₑ=2.5 kΩ; Lₘ=100μ; Rₛ=0.4Ω; Cₛ=3.5 pF.

FIG. 6 is a flowchart 600 for a method of assembling a transformer, according to embodiments. For exemplary purposes, embodiments of the method are described with respect to transformer 100. Steps may be performed in a different order or overlappingly. For example, step 620 could be performed before step 610, or performance of these steps could overlap in time.

At step 610, primary winding 150 is arranged or wound around core portion 110. Primary winding 150 may be wound by beginning with a first turn 151 proximate first distal end 112 and continuing to add turns 151 in first layer 152, extending towards first lengthwise endpoint 113. Subsequently, the winding direction is reversed, and turns 151 are added in second layer 153 extending back towards first distal end 112. Adjacent turns 151 may be spaced by a constant distance. Additional layers may be added (e.g., third and fourth layers, fifth and sixth layers, etc.).

At step 620, secondary winding 160 is arranged or wound around core portion 110.

Secondary winding 160 may be wound by beginning with a first turn 161 proximate second distal end 115 and continuing to add turns 161 in first layer 162, extending towards second lengthwise endpoint 116. Subsequently, the winding direction is reversed, and turns 161 are added in second layer 163 extending back towards second distal end 115. Adjacent turns 161 may be spaced by a constant distance. Additional layers may be added (e.g., third and fourth layers, fifth and sixth layers, etc.).

At step 630, upper core portion 140 may be attached to first lateral core portion 120 and/or second lateral core portion 130. For example, an adhesive may be used and a gap between upper core portion 140 and first lateral core portion 120 may be maintained, as well as a gap between upper core portion 140 and second lateral core portion 130. Optionally, upper step 630 may be performed after steps 610 and 620. By adding upper core portion 140 after arranging primary winding 150 and secondary winding 160 on core portion 110, manufacturing may be simplified.

It will be understood by those skilled in the art that various changes may be made and equivalents may be substituted without departing from the scope of the novel techniques disclosed in this application. In addition, many modifications may be made to adapt a particular situation or material to the teachings of the novel techniques without departing from its scope. Therefore, it is intended that the novel techniques not be limited to the particular techniques disclosed, but that they will include all techniques falling within the scope of the appended claims.

1. A transformer, comprising:
a core portion including a first lengthwise region extending between a first distal end of the core and a first lengthwise endpoint and a second lengthwise region next to the first lengthwise region extending between a second distal end of the core and a second lengthwise endpoint;
a primary winding arranged around the first lengthwise region of the core portion, wherein the primary winding comprises a plurality of layers, wherein each layer comprises a plurality of turns, wherein adjacent turns in each layer are arranged at a constant distance from each other; and
a secondary winding arranged around the second lengthwise region of the core portion, wherein the secondary winding comprises a plurality of layers, wherein each layer comprises a plurality of turns, wherein adjacent turns in each layer are arranged at a constant distance from each other,
wherein the plurality of turns of the primary winding are wound around the first lengthwise region starting proximate the first distal end and extending towards the first lengthwise endpoint in a first layer, and then reversing direction and extending back towards the first distal end, thereby forming two layers of turns in a second layer, the second layer being arranged around the first layer,
wherein the plurality of turns of the second winding are wound around the second lengthwise region starting proximate the second distal end and extending towards the second lengthwise endpoint in a first layer, and then reversing direction and extending back towards the second distal end in a second layer, the second layer being arranged around the first layer,
wherein a first portion of a capacitor is formed in the primary winding by one turn from each layer directly facing the first lengthwise endpoint,
wherein a second portion of the capacitor is formed in the secondary winding by one turn from each layer directly facing the second lengthwise endpoint.

2. The transformer of claim 1, wherein the number of layers in the primary winding is two, and wherein the number of layers in the secondary winding is two.

3. The transformer of claim 1, wherein centerline of wire in the first layer of the primary winding is substantially aligned with centerline of wire in the second layer of the primary winding, and wherein centerline of wire in the first layer of the secondary winding is substantially aligned with centerline of wire in the second layer of the secondary winding.

4. The transformer of claim 1, further comprising a first primary terminal, a second primary terminal, a first secondary terminal, a second secondary terminal, a first primary lead wire connected to the first primary terminal, a second primary lead wire connected to the second primary terminal, a first secondary lead wire connected to the first secondary terminal, and a second secondary lead wire connected to the second secondary terminal,
wherein an initial turn in an inner-most layer of the primary winding is connected to the first primary lead wire,
wherein a final turn in an outer-most layer of the primary winding is connected to the second primary lead wire,
wherein an initial turn in an inner-most layer of the secondary winding is connected to the first secondary lead wire, and
wherein a final turn in an outer-most layer of the secondary winding is connected to the second secondary lead wire.

5. The transformer of claim 1, wherein a capacitance of the capacitor comprises between approximately 0.1-1.5 pF.

6. The transformer of claim 5, wherein the capacitance is approximately 0.7 pF.

7. The transformer of claim 1, wherein the leakage inductance comprises between 10-12 μH.

8. The transformer of claim 1, further comprising:
a first lateral core portion coupled with the first distal end of the core portion;
a second lateral core portion coupled with the second distal end of the core portion; and
an upper core portion coupled with the first lateral core portion and the second lateral core portion.

9. The transformer of claim 8, wherein the first lateral core portion is directly coupled with the first distal end of the core portion, and wherein the second lateral core portion is directly coupled with the second distal end of the core portion.

10. The transformer of claim 9, wherein the first lateral core portion and the core portion are integrated, and wherein the second lateral core portion and the core portion are integrated.

11. The transformer of claim 8, wherein the upper core portion is adhered to the first lateral core portion and to the second lateral core portion.

12. The transformer of claim 1, wherein the transformer comprises a gate-drive transformer.

13. The transformer of claim 1, wherein the first layer of the primary winding and the first layer of the secondary winding are wound directly on the core portion.

14. The transformer of claim 1, wherein the primary winding comprises between approximately 10-40 turns, and wherein the secondary winding comprises between approximately 10-40 turns.

15. The transformer of claim 14, wherein the primary winding comprises 24 turns, and wherein the secondary winding comprises 24 turns.

16. A method for assembling a transformer including a core portion having a first lengthwise region defined by a first distal end and a first lengthwise endpoint, a second lengthwise region defined by a second distal end and a second lengthwise endpoint, and a core portion, the method comprising:
arranging a primary winding around the core portion by beginning the primary winding proximate the first distal end of the core portion and continuing to add turns in a first layer extending towards the first lengthwise endpoint, and subsequently reversing direction and continuing to add turns in a second layer extending back towards the first distal end, wherein adjacent turns are spaced by a constant distance;
arranging a secondary winding around the core portion by beginning the secondary winding proximate the second distal end of the core portion and continuing to add turns in a first layer extending towards the second lengthwise endpoint, and subsequently reversing direction and continuing to add turns in a second layer extending back towards the second distal end, wherein the adjacent turns are spaced by a constant distance.

17. The method of claim 16, wherein the transformer further includes a first lateral core portion coupled to the first distal end of the core portion, and a second lateral core portion coupled to the second distal end of the core portion, the method further comprising attaching an upper core portion to the first lateral core portion and to the second lateral core portion.

18. The method of claim 17, wherein attaching the upper core portion is performed after arranging the primary winding and arranging the secondary winding.

19. The method of claim 17, wherein attaching the upper core portion comprises forming a gap between the upper core portion and the first lateral core portion, and forming a gap between the upper core portion and the second lateral core portion.

20. The method of claim 16, further comprising:
forming a third layer and a fourth layer in the primary winding as like forming the first layer and the second layer of the primary winding; and
forming a third layer and a fourth layer in the secondary winding as like forming the first layer and the second layer of the secondary winding.
